(19) United States
(12) Patent Application Publication
(10) Pub. No.: US 2006/0262902 A1
(43) Pub. Date: Nov. 23, 2006

(54) Security X-ray screening system

(75) Inventor: Willard H. Wattenburg, Walnut Creek, CA (US)

Correspondence Address: Eddie E. Scott;Assistant Laboratory Counsel, Lawrence Livermore National Laboratory, P.O. Box 808, L-703, Livermore, CA, 94551, US

(73) Assignee: The Regents of the University of California

(21) Appl. No.: 11/418,991

(22) Filed: May 5, 2006

Related U.S. Application Data
(60) Provisional application No. 60/683,008, filed on May 19, 2005.

(51) Int. Cl. G01N 23/04

(52) U.S. Cl. 378/57; 378/62

(57) ABSTRACT

A security X-ray screening system comprises an X-ray scanner that scans an individual and produces an image signal. An image processor connected to the X-ray scanner receives the image signal and processes the image signal to produce a distorted image of the individual. In one embodiment the image processor stretches, elongates, and/or re-sizes sections of the image signal and produces the distorted image of the individual.

### CROSS-REFERENCE TO RELATED APPLICATIONS

This application claims the benefit of U.S. Provisional Patent Application No. 60/683,008 by Willard Wattenburg filed May 19, 2005 and titled “Security X-Ray Screening System That Avoids Invasion of Privacy by Gross Distortion of Displayed Images of Human Profiles.” U.S. Provisional Patent Application No. 60/683,008 by Willard Wattenburg filed May 19, 2005 and titled “Security X-Ray Screening System That Avoids Invasion of Privacy by Gross Distortion of Displayed Images of Human Profiles” is incorporated herein by this reference.

The United States Government has rights in this invention pursuant to Contract No. W-7405-ENG-48 between the United States Department of Energy and the University of California for the operation of Lawrence Livermore National Laboratory.

### BACKGROUND

1. Field of Endeavor

The present invention relates to security X-ray screening systems and more particularly to a security X-ray screening system that avoids invasion of privacy by distortion of displayed images of human profiles.

2. State of Technology

United States Patent Application No. 2004/0162755 by Peter John Muller for an airport passenger processing and surface transportation system published Aug. 19, 2004 provides the following state of technology information: “The process of transferring large numbers of the public from surface to air transportation has historically been accomplished through buildings known as terminals and concourses. These may be separate structures connected by some form of public surface transportation, or they may be contained within one building. The purpose of the terminal building is primarily to accommodate two functions—ticketing and security. The ticketing function involves selling tickets to passengers, confirming schedules, routes and seat assignments, issuing boarding passes and checking bags. The security function involves confirming the identity of boarding pass holders and screening passengers and bags for items that could be used to support a terrorist attack or aircraft hijacking.”

United States Patent Application No. 2003/0225612 by Russell Alan DeSimone, et al for a Method and system for implementing security in the travel industry published Dec. 4, 2003 provides the following state of technology information: “As the number of people that travel for business and personal reasons generally continues to increase, the safety and security of passengers continues to be an important issue for carriers, governments, and the general public. Security in the modern travel industry first garnered significant attention in the 1970s with the hijacking of several commercial passenger airplanes. For instance, in 1973, a series of flights were hijacked to Cuba. Many of the advances and improvements in travel security have been centered around the airline industry, but have applicability to the entire travel industry. For example, in an attempt to prevent passengers from carrying un-permitted guns onto aircraft, the Federal Aviation Administration (FAA) required that all passengers be screened prior to boarding using metal detectors. Later, X-ray technology was added at airports to allow screeners to examine carry-on luggage more thoroughly. These techniques were reasonably effective in preventing hijackings in which a passenger carrying a weapon attempted to divert a flight en route. However, security problems in the travel industry, and particularly in the air travel sector, persisted. Screening of passengers proved ineffective against terrorists whose goal was not to hijack the aircraft, but rather to destroy it in flight by means of explosives. The bombing of Pan Am flight 103 in 1988 expanded the need for security to include an explosive detection system (EDS) capable of detecting plastic explosives. The best technology available in 1988 was inadequate for this task, leading to the development of a device by InVision, a company based in Foster City, Calif., that functions similarly to a CAT Scan. Other similar detection machines have since been produced by other manufacturers.”

International Patent No. WO2004111963 by Quantum Magnetics, Inc. for a combined system user interface for centralized monitoring of a screening checkpoint for passengers and baggage published Dec. 23, 2004 provides the following state of technology information: “A variety of detection and screening systems have been developed. Some systems are designed to detect explosives, weapons, and other contraband items. Traditional explosives detection systems include those that are intended to screen individuals, while other systems are designed to screen baggage, luggage, and other items. Similarly, existing weapons detection systems utilize various scanning methods to screen individuals and variously sized containers for weapons, improvised explosives devices (IEDs), and other threat objects. Checkpoint screening systems have been implemented in a variety of different applications including airports, seaports, public buildings, public transportation facilities, prisons, hospitals, power plants, office buildings, hotels, and casinos, among others. Many existing checkpoint screening systems employ a limited assortment of screening devices. For example, airport screening checkpoints often include weapons and metal detection systems, but do not routinely utilize explosives detection systems. Explosives screening has become increasingly more important, resulting in the implementation of explosives detection devices in some checkpoints. Lack of communication and centralized monitoring among various detection devices is a common problem encountered by existing checkpoint screening personnel at such screening system installations. While there have been some attempts to create a more comprehensive and reliable checkpoint screening system, these attempts have not been entirely successful.”

International Patent No. WO9713685 by The ADI Group Limited Hills for a monitoring system published Apr. 17, 2004 provides the following state of technology information: “The importance of airport passenger monitoring systems is evident in view of the vulnerability and exposure to crime of airports and flights. Passenger monitoring systems are required both for the benefit of the passenger and also for commercial reasons. Such a monitoring system should be as comprehensive as possible. At the same time, he passenger monitoring system should be efficient and cost effective and not so obtrusive as to be annoying to passengers. While the monitoring systems are rarely operated by an airline itself, the frustrated passenger is likely to associate failings and delays in his or her progress through the airport with the airline.”

### SUMMARY

Features and advantages of the present invention will become apparent from the following description. Applicants are providing this description, which includes drawings and examples of specific embodiments, to give a broad representation of the invention. Various changes and modifications within the spirit and scope of the invention will become apparent to those skilled in the art from this description and by practice of the invention. The scope of the invention is not intended to be limited to the particular forms disclosed and the invention covers all modifications, equivalents, and alternatives falling within the spirit and scope of the invention as defined by the claims.

Modem X-ray security screening systems can see through most clothing and display the profile of the screened person in such detail as to invade the privacy and sense of decency of many people. The United States government has recently announced that it will install backscatter X-ray machines in airports. This has created a great outcry from people and civil rights groups who are concerned that the display of human profiles will invade the privacy of individuals and that the images of people will be recorded for pornographic purposes. The present invention removes all or most of the privacy invasion concern by rendering the image of a scanned person in a distorted form such that the displayed image reveals no accurate details about the body of the person scanned.

The present invention provides a security X-ray screening system. The security X-ray screening system comprises the scanning an individual and the production of an image signal representing the individual. The image signal representing the individual is processed by an image processor. The image processor produces a distorted image of the individual. In one embodiment, the present invention provides an X-ray screening apparatus comprising an X-ray scanner that scans the individual and produces an image signal and an image processor connected to the X-ray scanner. The image processor receives the image signal and processes the image signal to produce a distorted image of the individual.

In one embodiment the image processor stretches sections of the image signal and produces a distorted image of the individual. In one embodiment the image processor elongates sections of the image signal and produces a distorted image of the individual. In one embodiment the image processor re-sizes sections of the image signal and produces a distorted image of the individual. In one embodiment the image processor stretches, elongates, and re-sizes sections of the image signal and produces a distorted image of the individual. In one embodiment the image processor identifies reference points of the image and uses the reference points to stretch, and/or elongate, and/or re-size sections of the image to produce the distorted image of the individual. In one embodiment the image processor identifies constant points (reference points) as the top-most, bottom-most, and side points of the image of in the image signal, and uses the constant (reference points) points to stretch, and/or elongate, and/or re-size sections of the image signal to provide the distorted image of the individual.

The invention is susceptible to modifications and alternative forms. Specific embodiments are shown by way of example. It is to be understood that the invention is not limited to the particular forms disclosed. The invention covers all modifications, equivalents, and alternatives falling within the spirit and scope of the invention as defined by the claims.

### BRIEF DESCRIPTION OF THE DRAWINGS

The accompanying drawings, which are incorporated into and constitute a part of the specification, illustrate specific embodiments of the invention and, together with the general description of the invention given above, and the detailed description of the specific embodiments, serve to explain the principles of the invention.

FIG. 1 illustrates one embodiment of a security X-ray screening system that avoids invasion of privacy by distortion of the displayed image of the human profile.

FIG. 2 illustrates an image of an individual passenger prior to the image being distorted.

FIG. 3 illustrates the image of an individual passenger produced by the security X-ray screening system of the present invention.

FIG. 4 illustrates one embodiment of the processor that distorts the image of the individual.

FIG. 5 is a flow diagram illustrating the processing that distorts the image of the individual.

FIG. 6 illustrates an image of an individual passenger of another embodiment of a security X-ray screening system that avoids invasion of privacy by distortion of the displayed image of the human profile.

FIG. 7 illustrates another embodiment of a processor that distorts the image of an individual passenger being screened.

FIG. 8 shows an image of an individual passenger produced by the embodiment of the security X-ray screening system shown in FIG. 7.

### DETAILED DESCRIPTION OF THE INVENTION

Referring to the drawings, to the following detailed description, and to incorporated materials, detailed information about the invention is provided including the description of specific embodiments. The detailed description serves to explain the principles of the invention. The invention is susceptible to modifications and alternative forms. The invention is not limited to the particular forms disclosed. The invention covers all modifications, equivalents, and alternatives falling within the spirit and scope of the invention as defined by the claims.

Because of the threat of terrorism, it is desirable to have a way to detect explosives, weapons or other contrabands concealed by individuals on their persons. Most inspection systems employ ionizing radiation to form images of items under inspection. Human operators with image analysis computer systems study these images to detect contraband objects.

The article “Backscatter X-Ray Screening Technology” in the Electronic Privacy Information Center, http://www.epic.org/privacy/airtravel/backscatter/ describes airport passenger screening systems and some of the issues raised by the systems as follows: “The application of this new X-ray technology to airport screening uses high energy X rays that are more likely to scatter than penetrate materials as compared to lower-energy X rays used in medical applications. Although this type of X ray is said to be harmless it can move through other materials, such as clothing. A passenger is scanned by rastering or moving a single high energy X-ray beam rapidly over their form. The signal strength of detected backscattered X rays from a known position then allows a highly realistic image to be reconstructed. Since only Compton scattered X rays are used, the registered image is mainly that of the surface of the object/person being imaged. In the case of airline passenger screening it is her nude form. The image resolution of the technology is high, so details of the human form of airline passengers present privacy challenges.” The article “Backscatter X-Ray Screening Technology” in the Electronic Privacy Information Center is incorporated herein by reference.

The article “Airline Passenger Security Screening: New Technologies and Implementation Issues” Publication NMAB-482-1 National Academy Press, Wash., D.C., 1996, describes some of the privacy challenges as follows: “The public acceptance issues associated with new passenger screening technologies focus on the extent to which people are willing to tolerate the screening procedures. While a screening technology and its operator may function properly, the ultimate success of the procedure requires its acceptance by the people being screened. . . . Privacy is likely to be the most significant public acceptance issue associated with imaging technologies. Displaying an image of the body on a monitor will obviously be of concern to a significant percentage of people passing through screening checkpoints. This concern may be greater among flight crews and airport employees who are screened more frequently and who may be known to or familiar with the operators. It is important to address this concern before imaging technologies can gain acceptance. Steps to alleviate concerns may include: masking portions of the displayed image or distorting the image to make it appear less ‘human;’ using operators of the same sex as the subject to view the images; displaying the images out of the view of everyone except the screening personnel; providing guarantees that the images will not be preserved beyond the brief screening procedure, except when questionable objects are detected; offering alternative screening procedures for those who object to imaging.” The article “Airline Passenger Security Screening: New Technologies and Implementation Issues” is incorporated herein by reference.

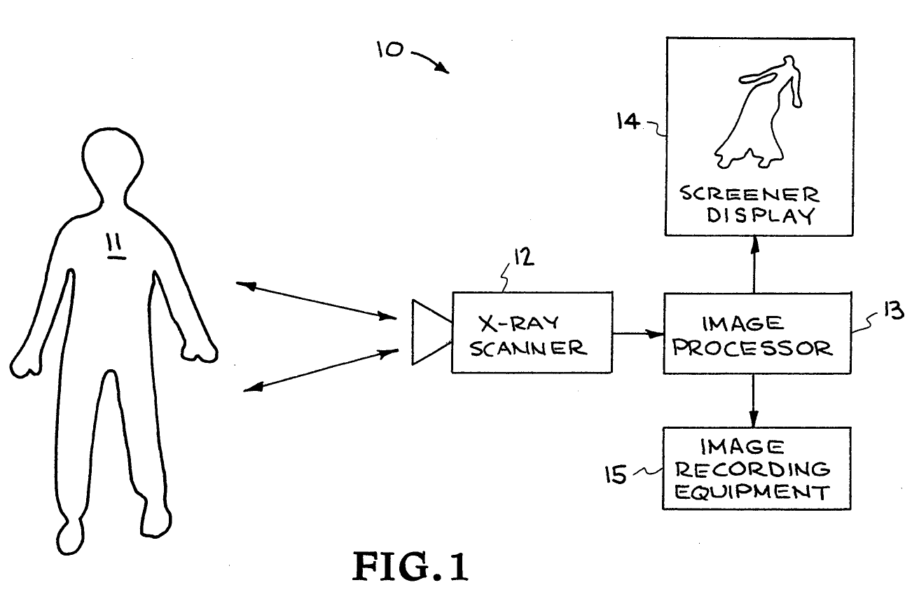

Referring now to the drawings and in particular to FIG. 1, one embodiment of a security X-ray screening system that avoids invasion of privacy by distortion of displayed images of human profiles is illustrated. The security X-ray screening system is designated generally by the reference numeral 10. The security X-ray screening system 10 is an airport inspection system used to screen passengers. The security X-ray screening system 10 is used to locate contraband items carried by an individual passenger 11.

The security X-ray screening system 10 includes an image processor unit 13 installed between the output of an X-ray scanner 12 and the input to a visual display 14. The visual display 14 is viewed by security screener personnel. The visual display 14 can also be connected to image recording equipment 15. The image recording equipment 15 can be connected to the image processor 13.

It is to be understood that the security X-ray screening system 10 includes “state-of-the-art” components and systems. These components and systems are described in printed publications and are in use in airports around the world. For example, United States Patent Application No. 2005/0110672 by Apostle G. Cardiasmenos and Paul J. DeLia, published May 26, 2005, describes basic equipment and systems used in an airport passenger screening system as follows: “an inspection system such as may be used at an airport to screen passengers boarding airplanes. The invention is generally applicable in any situation in which it is desirable to locate contraband items, such as may be carried on, in or under the clothing of an individual being scanned. The invention will be explained using a security checkpoint at an airport as an example application. Inspection system includes a portal and an operator inspection station. Portal includes a doorway through which a person being screened enters the portal. Preferably, a similar sized opening is provided on the opposite side of the portal to allow the person to exit the portal. However, it is possible that a portal could be constructed with a single opening, requiring the person to enter and exit the portal through the same opening. Two openings provide more convenient movement of individuals through the portal. For example, individuals may line up for screening on one side of the portal. People may pass continuously through the portal, with those cleared by the screening being allowed to pass the security checkpoint. Those not cleared by the screening may be diverted upon exiting the portal for further inspection or other steps to ensure they are not carrying contraband. Two openings also facilitate environmental control within the portal, such that the inside of the portal is at the same temperature and/or relative humidity as the surrounding environment. In use, a person steps into the portal and stands in front of back wall. A visible image is formed of the person against back wall and processed for display on operator station. At the same time, the system scans the region near to and over the surface of the person and measures the strength of the millimeter wave radiation emanating from the person and the nearby regions. Preferably, this radiation is presented in the form of a millimeter wave image. The measured values of the millimeter wave radiation are sent to operator station where an embedded automatic target recognition algorithm may process the measured values to determine if contraband items are present on, in or under the clothing covering the individual being scanned. Preferably, once the visible and passive millimeter wave images of the front of a person are formed, the person turns to allow images to be formed from different angles. For example the person may face back wall for an image of the back of the person to be formed. Images may also be formed with a person's sides facing the camera. If the inspection system detects contraband carried on, under or inside the clothing of the person, an indication of the location of the contraband will be presented to an operator through operator interface. Where the system indicates contraband, the person may be denied passage through the checkpoint, searched or otherwise subject to other security screening. Information presented on operator interface may guide the search, with the search starting in the area indicated to contain contraband, with a more complete body search being done second, if necessary or desirable. Alternatively, some other appropriate action may be taken, such as denying the person access to specific locations. The appropriate action taken in response to indications that people have concealed weapons or other contraband on their persons will depend on the intended use of the inspection system. Also, it is not necessary that images be presented to a human operator. Decisions about whether a person has concealed contraband may be made by a computer programmed to apply threat detection algorithms to the images obtained by inspection system.” United States Patent Application No. 2005/0110672 by Apostle G. Cardiasmenos and Paul J. DeLia, published May 26, 2005 is incorporated herein by reference.

A comprehensive report of “state-of-the-art” components and systems that can be included in the security X-ray screening system 10 is provided in the September 2002 Policy Study No. 29, “Improving Airport Passenger Screening,” by Robert W. Poole, Jr. The comprehensive report Policy Study No. 29, September 2002, “Improving Airport Passenger Screening” by Robert W. Poole, Jr. is incorporated herein by reference.

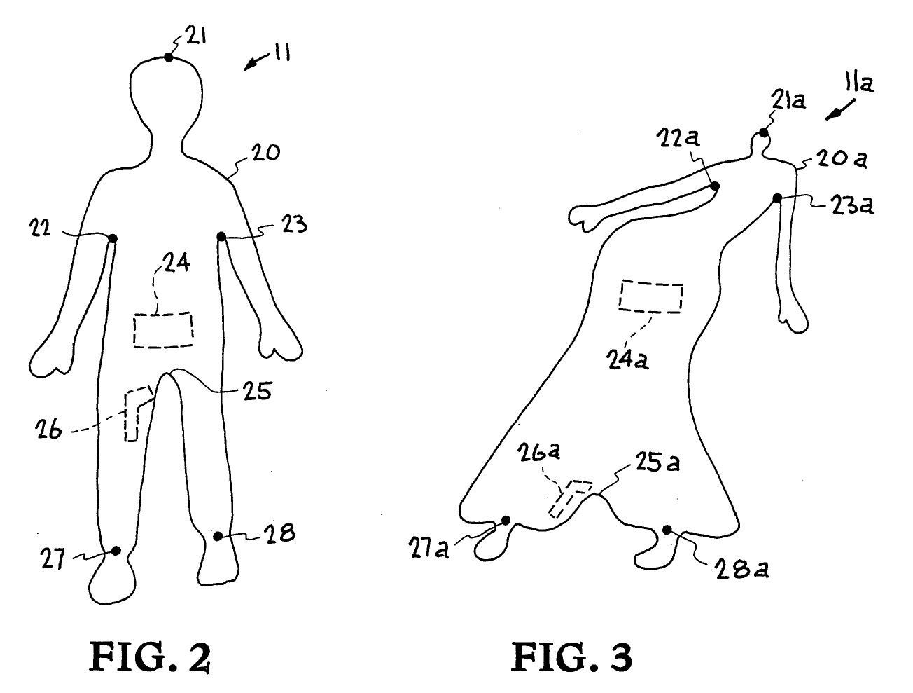

Referring now to FIG. 2, additional details of the image 11 of the individual passenger shown in FIG. 1 is illustrated. The passenger image 11 would normally be the image is displayed for view by the security screener personnel using existing X-ray security scanning systems. The passenger image 11 illustrated in FIG. 2 show all of the parts of a human body including a torso 20, a head 21, armpits 22 and 23, groin 25, and legs 27 and 28. Note that the passenger image 11 illustrated in FIG. 2 also shows the outline of a thin body pouch 24 that contains suspicious material that could be low density explosives. The passenger image 11 also shows a handgun 26 strapped to the leg 27 of the person being scanned.

Modem X-ray security screening systems can see through most clothing and display the profile of the screened person in such detail as to invade the privacy and sense of decency of many people. The United States government has recently announced that it will install backscatter X-ray machines in United States airports. This has created a great outcry from people and civil rights groups who are concerned that the display of human profiles will invade the privacy of individuals and that the images of people will be recorded for pornographic purposes. The article “Airport Screeners Could Get X-Rated X-Ray Views” by Joe Sharkey, published May 24, 2005 in the New York Times provide examples of the outcry from people and civil rights groups. The New York Times article “Airport Screeners Could Get X-Rated X-Ray Views” by Joe Sharkey, published May 24, 2005 is incorporated herein by reference.

The passenger image 11 would normally be the image that is sent from the X-Ray scanner 12 to the screener display 14 and be displayed for view by the security screener personnel. With modern X-Ray scanning equipment, details of the human body are shown that are considered to invade the privacy and sense of decency of many people.

In the present invention, the image processor, unit 13, of the security X-ray screening system 10 stretches, and/or elongates, and/or re-sizes sections of the real profile of the airline passenger 11 to produce a distorted image. This distorted image bears no resemblance to the real profile of the person being scanned. The distorted image avoids showing details of the human body that are considered to invade the privacy and sense of decency of many people. The distorted image is the image that is sent from the image processor 13 to the screener display 14 and the distorted image is the image that is displayed for view by the security screener personnel.

Referring now to FIG. 3, the distorted image of the image of an individual passenger 11 produced by the security X-ray screening system 10 of the present invention is illustrated. This distorted image is designated generally by the reference numeral 11A. The image 11A is distorted such that the displayed image reveals no accurate details about the body of the person scanned. The distorted image 11A is all that is displayed to the security screener (or recorded) so that there is no presentation of the person's actual body profile in a form that would reveal personal characteristics. The image 11A produced by the security X-ray screening system 10 removes all or most of the privacy invasion concerns.

Note that the distorted passenger image 11A illustrated in FIG. 3 shows the outline of the thin body pouch 24A that contains suspicious material that could be low density explosives. The distorted passenger image 11A also shows the handgun 26A strapped to the leg 27A of the person being scanned. The image processor unit 13 incorporates the high density and suspicious items 24A and 26A in the image 11A in the same relative positions as they were detected. For comparison see the image 11 of FIG. 2.

The passenger image 11 illustrated in FIG. 2 show all of the parts of a human body including the torso 20, head 21, armpits 22 and 23, groin 25, and legs 27 and 28. As illustrated in FIG. 3 the distorted image 11A shows the counterparts of all of the parts of a human body including the torso 20A, head 21A, armpit 22A, armpit 23A, groin 25A, leg 27A, and leg 28A. The processing logic of image processor 13 uses certain “constant points or reference points” in the standard profile presented to it. For example referring to FIG. 2, the image processor 13 in a face-on image utilizes the head 21 (Reference Point #1), armpit 22 (Reference Point #2, armpit 23 (Reference Point #3), leg 27 (Reference Point #4), and leg 28 (Reference Point #5) as constant points or reference points. The head 21, armpits 22 and 23, and legs 27 and 28 are easily located as the intersections of the arms and legs with the central torso 20.

The image processor, unit 13, of the security X-ray screening system 10 stretches, and/or elongates, and/or re-size sections of the real profile of the airline passenger to produce a distorted image 11A illustrated in FIG. 3. This distorted image 11A bears no resemblance to the real profile of the person being scanned. The distorted image 11A avoids showing details of the human body that are considered to invade the privacy and sense of decency of many people. The distorted image 11A is sent from the image processor 13 to the screener display 14 and the distorted image 11A is the image that is displayed for view by the security screener personnel.

In one embodiment of the present invention, the image processor, unit 13, processes the image signal from the X-Ray scanner 12 to produce the distorted image 11A of the individual 11 that has acceptable distortion. “Acceptable Distortion” is defined as distortion determined to be acceptable by a statute, a rule, an official procedure, case law, or accepted practice as sufficient to avoid violation of privacy. This includes current and future statutes, rules, official procedures, case law, and accepted practice.

In another embodiment of the present invention, the image processor, unit 13, processes the image signal from the X-Ray scanner 12 to produce the distorted image 11A of the individual 11 that has gross distortion. “Gross Distortion” is defined as distortion that distorts details of the human form sufficiently that sensitive body parts do not appear graphic.

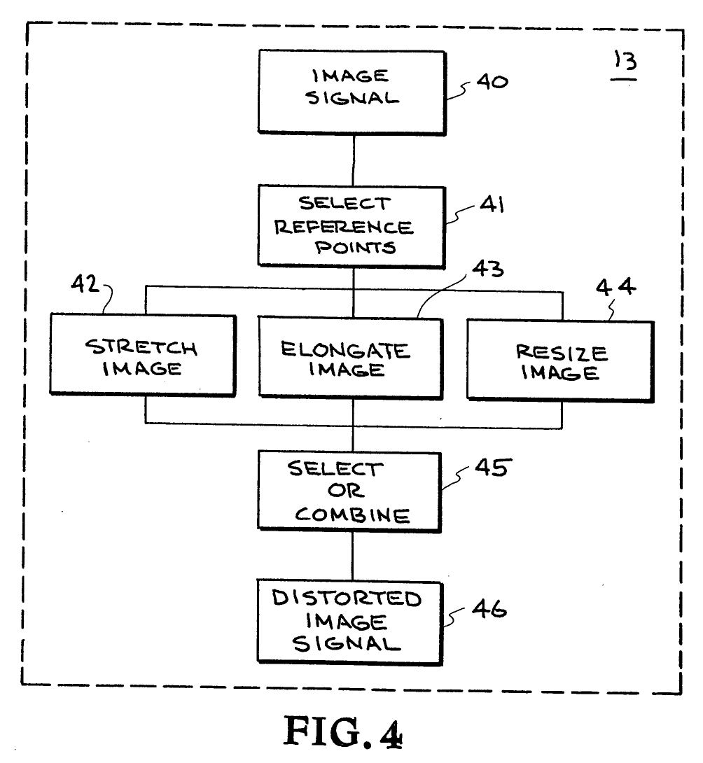

Referring now to FIG. 4, one embodiment of the image processor, unit 13, that produces the distorted image 11A of the individual passenger 11 is illustrated. The image signal 40 from the X-Ray scanner 12 is sent to a processor 41 that selects reference points for processing. Processors for selecting reference points for processing are known in the prior art and need not be described in detail here. For example, U.S. Pat. No. 3,820,895 issued Jun. 28, 1974 titled “Method and Apparatus for Mensuration of Three-dimensional Objects and of Steromodels of such Objects” and U.S. Pat. No. 6,459,895 issued Oct. 1, 2002 and titled “Method for Stitching Partial Radiation Images to Reconstruct a Full Image” describe processors for selecting reference points for processing. U.S. Pat. No. 3,820,895 and U.S. Pat. No. 6,459,895 are incorporated herein by reference.

The head 21 (Reference Point #1), armpit 22 (Reference Point #2), armpit 23 (Reference Point #3), leg 27 (Reference Point #4), and leg 28 (Reference Point #5) illustrated in FIG. 2 of the image of the individual 11 are identified by the processor 41 as constant points or reference points. The processing logic of the processor 41 uses the constant points or reference points 1-5 in the standard profile presented to it. The head 21, armpits 22 and 23, and legs 27 and 28 are easily located as the intersections of the arms and legs with the central torso 20.

The processor 42 utilizes the signal produced by processor 41 to stretch the image. The processor 43 utilizes the signal produced by processor 41 to elongate the image. The processor 44 utilizes the signal produced by processor 41 to resize the image. The processor 45 utilizes signals produced by processors 42 and/or 43 and/or 44 to provide the distorted image signal 46. The type of processors 42, 43, 44, and 45 are known in the prior art and need not be described in detail here.

The distorted image signal 46 is distorted such that the displayed image reveals no accurate details about the body of the person scanned. The distorted image 11A of FIG. 3 produced by the distorted image signal 46 is all that is displayed to the security screener or recorded so that there is no presentation of the person's actual body profile in a form that would reveal personal characteristics. In one embodiment, the image processor unit 13 processes the image signal from the X-Ray scanner to produce a distorted image signal 46 of the individual that has acceptable distortion which is defined as distortion determined to be acceptable by a statute, a rule, an official procedure, case law, or accepted practice as sufficient to avoid violation of privacy. This includes current and future statutes, rules, official procedures, case law, and accepted practice. In another embodiment, the image processor unit 13 processes the image signal from the X-Ray scanner to produce a distorted image signal 46 of the individual that has gross distortion which is defined as distortion that distorts details of the human form sufficiently that sensitive body parts do not appear graphic. The distorted image produced by the security X-ray screening system removes privacy invasion concerns.

The distorted image produced by the security X-ray screening system performs all of the security clearance functions. As illustrated in FIG. 3, the distorted image 11A shows the outline of the thin body pouch 24A that contains suspicious material that could be low density explosives. The distorted image 11A also shows the handgun 26A strapped to the leg 27A of the person being scanned. The image processor, unit 13, displays the high density and suspicious items 24A and 26A in the same relative positions as they were detected in comparison to the constant or reference points 1-5. Using the set of constant reference points 1-5 the image processor 13 allows the security screener to select and enhance any area such as 24A or 26A of FIG. 3. The screener can do this by touching the screen area containing any suspicious object or clicking on the area with a pointer directed by a mouse control. Once a local area such as 24A is expanded in the image 11A of FIG. 3, it can replace the rest of the displayed profile so that all semblance to the person's actual profile is absent in any recorded images that are stored for further analysis or as evidence if so desired.

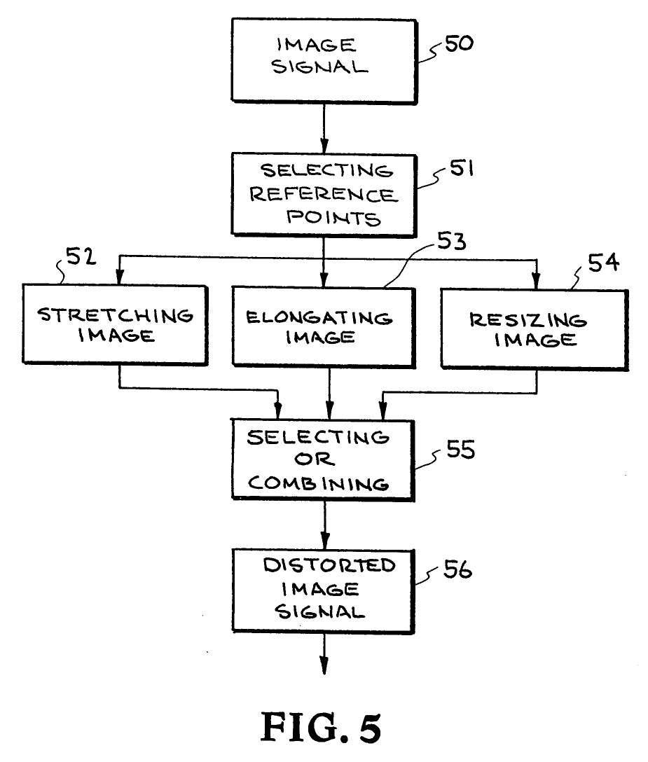

Referring now to FIG. 5, the image processing method that produces the distorted image of the individual passenger is illustrated by a flow chart. In step 1, the image signal 50 from the X-Ray scanner 12 is used to produce a distorted image.

Step 2 comprises selecting or combining reference points 51 for processing. With reference to the passenger images 11 of FIG. 2 and 11A of FIG. 3, the head (Reference Point #1), right armpit (Reference Point #2), left armpit (Reference Point #3), right leg (Reference Point #4), and left leg (Reference Point #5) are used as constant points or reference points. The head, armpits, and legs are easily located as the intersections of the arms and legs with the central torso.

Step 3 comprises stretching the image 52. Step 4 comprises elongating the image 53. Step 5 comprises resizing the image 54. In step 6 signals produced in steps 52 and/or 53 and/or 54 are used to provide the distorted image signal 56.

The distorted image signal 56 is distorted such that the displayed image reveals no accurate details about the body of the person scanned. The distorted image produced by the distorted image signal 56 is all that is displayed to the security screener or recorded so that there is no presentation of the person's actual body profile in a form that would reveal personal characteristics. In one embodiment, the distorted image produced by the distorted image signal 56 produces a distorted image of the individual that has acceptable distortion which is defined as distortion determined to be acceptable by a statute, a rule, an official procedure, case law, or accepted practice as sufficient to avoid violation of privacy. This includes current and future statutes, rules, official procedures, case law, and accepted practice. In another embodiment, the distorted image produced by the distorted image signal 56 produces a distorted image signal that has gross distortion which is defined as distortion that distorts details of the human form sufficiently that sensitive body parts do not appear graphic. The distorted image produced by the security X-ray screening system removes privacy invasion concerns.

Referring again to FIGS. 1 through 5, the security X-ray screening system that avoids invasion of privacy by distortion of displayed images of human profiles is summarized. The security X-ray screening system 10 is an airport inspection system used to screen passengers and locate contraband items carried by a passenger such as passenger 11. As shown in FIG. 3, the passenger 11 is carrying a thin body pouch 24 that contains suspicious material that could be low density explosives. The passenger 11 is also carrying a handgun 26 strapped to his leg.

The security X-ray screening system 10 utilizes the image processor, unit 13, between the X-ray scanner 12 and the visual display 14. The visual display 14 is viewed by security screener personnel and is connected to image recording equipment 15. The image processor unit 13 displays the high density and suspicious items 24 and 26; however, the security X-ray screening system 10 avoids invasion of privacy by producing an image that has acceptable distortion which is defined as distortion determined to be acceptable by a statute, a rule, an official procedure, case law, or accepted practice as sufficient to avoid violation of privacy. In one embodiment, the security X-ray screening system 10 avoids invasion of privacy by producing an image that has gross distortion which is defined as distortion that distorts details of the human form sufficiently that sensitive body parts do not appear graphic.

The image processor, unit 13, of the security X-ray screening system 10 stretches, and/or elongates, and/or re-sizes sections of the real profile of the airline passenger 11 to produce the distorted image 11A. This distorted image 11A bears no resemblance to the real profile of the person being scanned. The processing logic of the security X-ray screening system 10 uses the established “constant reference points 1-5” in any standard profile presented to it. For example, the image processor 13, in a face-on image utilizes the head 21, armpits 22 and 23, and legs 27 and 28 as constant reference points 1-5. The constant reference points 1-5 are used to stretch, and/or elongate, and/or re-size sections of the real profile of the airline passenger 11 to produce the distorted image 11A. This distorted image 11A bears no resemblance to the real profile of the person being scanned.

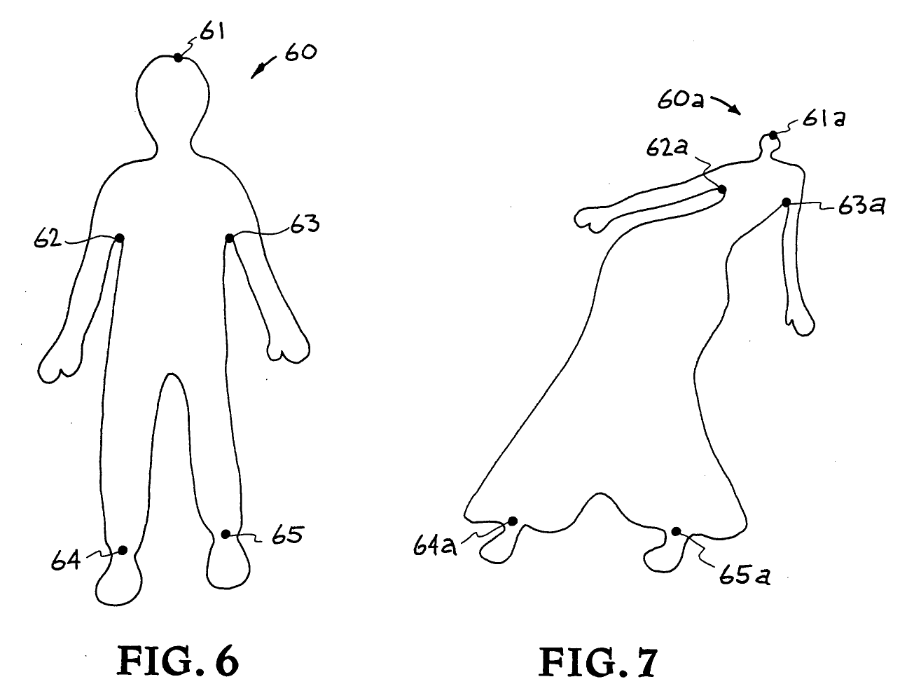

Referring now to FIG. 6, together with FIG. 1, another embodiment of an X-ray screening system for security screening an individual is illustrated. This embodiment of a security X-ray screening system avoids invasion of privacy by distortion of the displayed image of the human profile. As illustrated in FIG. 1, the security X-ray screening system 10 is an airport inspection system used to screen passengers. The security X-ray screening system 10 is used to locate contraband items carried by an individual passenger 11. The security X-ray screening system 10 includes an image processor, unit 13, installed between the output of the X-ray scanner 12 and the input to the visual display 14. The visual display 14 is viewed by security screener personnel. The visual display 14 can also be connected to the image recording equipment 15. The image recording equipment 15 can be connected to the image processor 13.

Referring now to FIG. 6, the X-ray scanner 12 provides a signal representing an image of a passenger 60 being screened. If this image was displayed it would show the passenger image 60 as illustrated in FIG. 6. The passenger image 60 shows all of the parts of a human body. Modem X-ray security screening systems can see through most clothing and display the profile of the screened person in such detail as to invade the privacy and sense of decency of many people. This has created a great outcry from people and civil rights groups who are concerned that the display of human profiles will invade the privacy of individuals and that the images of people will be recorded for pornographic purposes.

Referring now to FIG. 7, another embodiment of the image processor 13 of the security X-ray screening system that avoids invasion of privacy by distortion of the displayed image of the human profile is illustrated. The image processor unit 13 is installed between the output of the X-ray scanner 12 and the input to the visual display 14. The visual display 14 is viewed by security screener personnel. The visual display 14 can also be connected to the image recording equipment 15. The image recording equipment 15 can be connected to the image processor 13.

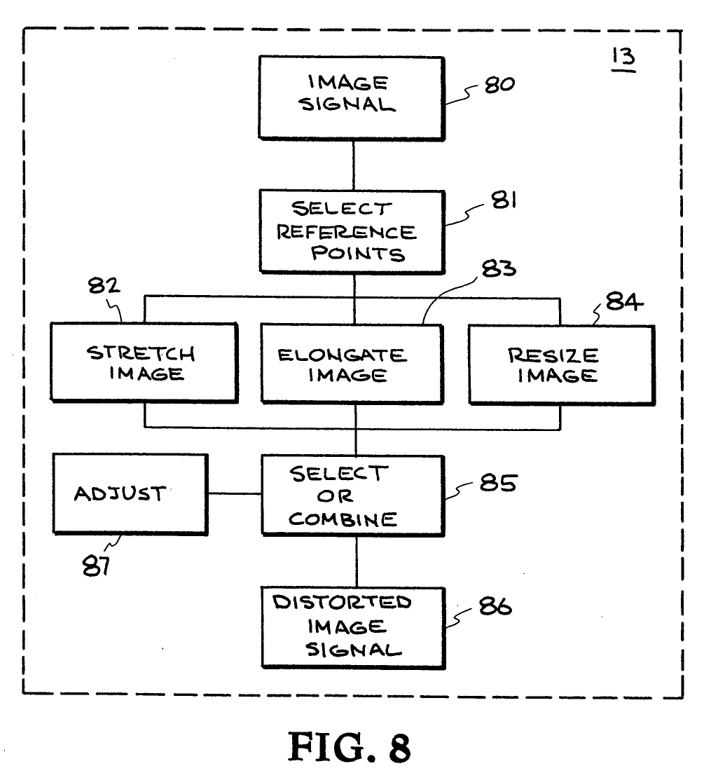

The image processor 13 produces a distorted image of the individual passenger 60. The distorted image is illustrated in FIG. 8 and designated generally by the reference numeral 60A. The distorted image 60A is distorted such that the displayed image reveals no accurate details about the body of the person scanned. The distorted image 60A is all that is displayed to the security screener or recorded so that there is no presentation of the person's actual body profile in a form that would reveal personal characteristics. The image processor unit 13 processes the image signal from the X-Ray scanner 12 to produce the distorted image signal of the individual and the image has acceptable distortion defined as distortion determined to be acceptable by a statute, a rule, an official procedure, case law, or accepted practice as sufficient to avoid violation of privacy. The image processor unit 13 can be adjusted to processes the image signal from the X-Ray scanner 12 to produce a distorted image signal of the individual wherein the image has gross distortion defined as distortion that distorts details of the human form sufficiently that sensitive body parts do not appear graphic. The distorted image 60A produced by the security X-ray screening system removes privacy invasion concerns.

Referring to FIG. 7 together with FIG. 6, the image signal 70 from the X-Ray scanner 12 is sent to a processor 71 that selects reference points for processing. The head 61 (Reference Point #1), right shoulder 62 (Reference Point #2), left shoulder 63 (Reference Point #3), right leg 64 (Reference Point #4), and left leg 65 (Reference Point #5) are identified by the processor 71 as constant points or reference points. The processing logic of the processor 71 uses the constant points or reference points 1-5 in the standard profile presented to it. The head 61 (Reference Point #1), right shoulder 62 (Reference Point #2), left shoulder 63 (Reference Point #3), right leg 64 (Reference Point #4), and left leg 65 (Reference Point #5) are easily located as intersections with the central torso of the image. The constant or reference points 1, 2, 3, 4, and 5 can be located as the top-most, bottom-most, and side points of the profile of the passenger being scanned 60. Processors for selecting reference points for processing are known in the prior art and need not be described in detail here. For example, U.S. Pat. No. 3,820,895 issued Jun. 28, 1974 titled “Method and Apparatus for Mensuration of Three-dimensional Objects and of Steromodels of such Objects” and U.S. Pat. No. 6,459,895 issued Oct. 1, 2002 and titled “Method for Stitching Partial Radiation Images to Reconstruct a Full Image” describe processors for selecting reference points for processing. U.S. Pat. No. 3,820,895 and U.S. Pat. No. 6,459,895 are incorporated herein by reference.

The processor 72 utilizes the signal produced by processor 71 to stretch the image. The processor 73 utilizes the signal produced by processor 71 to elongate the image. The processor 74 utilizes the signal produced by processor 71 to resize the image. The processor 75 utilizes signals produced by processors 72 and/or 73 and/or 74 to provide the distorted image signal 76. The distorted image signal 76 is distorted such that the displayed image reveals no accurate details about the body of the person scanned. The processor 77 connected to processor 75 provides adjustment for determining the degree of distortion and whether the signals from one or more of the signals from the processor 71 to stretch the image, the processor 73 to elongate the image, and/or the processor 74 to resize the image are used. The type of processors 72, 73, 74, 75, and 77 are known in the prior art and need not be described in detail here.

The distorted image in image signal 76 is all that is displayed to the security screener or recorded so that there is no presentation of the person's actual body profile in a form that would reveal personal characteristics. The distorted image produced by the security X-ray screening system performs all of the security clearance functions. The distorted image will detect suspicious material and objects. The image processor unit displays high density and suspicious items in the same relative positions as they were detected in comparison to the constant or reference points 1-5. Using the set of constant reference points 1-5 the image processor 13 allows the security screener to select and enhance any area. The screener can do this by touching the screen area containing any suspicious object or clicking on the area with a pointer directed by a mouse control. Once a local area is expanded in the image 60A of FIG. 8, it can replace the rest of the displayed profile so that all semblance to the person's actual profile is absent in any recorded images that are stored for further analysis or as evidence if so desired.

The security X-ray screening system allows the security screener to select and enhance any area where suspicious items appear. The screener does this by touching the screen area containing the suspicious object or clicking on the area with a pointer directed by a mouse control. Once the screener has selected the desired area, a specific “image data set” that consists of the reference points that are used to distort the image are identified. For example, the data set might consists of at least: (1) the 2-d coordinates of the raw image reference points, top, bottom and sides of the head, armpits, end of arms, crotch, end of legs, etc. and (2) the 2-d location and full outline of the suspicious objects (i.e., those detected by their apparent density or form). The algorithms used in the image processor unit transform this raw data set to an enlarged and/or enhanced “distorted image data set.” For example, the algorithms can use (1) and (2) above to isolate a section where suspicious items appear. The enlarged and/or enhanced “distorted image data set” allows an enlarged, enhanced, or enlarged and enhanced image to be shown on the screen. The enlarged, enhanced, or enlarged and enhanced distorted image is the only thing the machine allows the security screener to see or record.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

The invention claimed is:

1. An X-ray screening apparatus for security screening an individual, comprising:
an X-ray scanner that scans the individual and produces an image signal,
an image processor connected to said X-ray scanner that receives said image signal, and
at least one processor that processes said image signal and produces a distorted image of the individual.

2. The X-ray screening apparatus for security screening an individual of claim 1 wherein said at least one processor processes said image signal and produces an image of the individual that has acceptable distortion.

3. The X-ray screening apparatus for security screening an individual of claim 1 wherein said at least one processor processes said image signal and produces an image of the individual that has gross distortion.

4. The X-ray screening apparatus for security screening an individual of claim 1 wherein said image signal embodies an image of the individual and wherein said at least one processor includes a processor that receives said image signal and process said image signal by stretching sections of said image and producing said distorted image of the individual.

5. The X-ray screening apparatus for security screening an individual of claim 1 wherein said image signal embodies an image of the individual and wherein said at least one processor includes a processor that receives said image signal and process said image signal by elongating sections of said image and producing said distorted image of the individual.

6. The X-ray screening apparatus for security screening an individual of claim 1 wherein said image signal embodies an image of the individual and wherein said at least one processor includes a processor that receives said image signal and process said image signal by resizing sections of said image and producing said distorted image of the individual.

7. The X-ray screening apparatus for security screening an individual of claim 1 wherein said image signal embodies an image of the individual and wherein said at least one processor includes a processor that receives said image signal and process said image signal by stretching sections of said image or elongating sections of said image or resizing sections of said image and producing said distorted image of the individual.

8. The X-ray screening apparatus for security screening an individual of claim 1 wherein said image signal embodies an image of the individual and wherein said at least one processor includes a processor that receives said image signal, identifies constant points of said image, and uses said constant points to stretch, elongate, or re-size sections of said image and produce said distorted image of the individual.

9. The X-ray screening apparatus for security screening an individual of claim 1 wherein said image signal embodies an image of the individual and wherein said at least one processor includes a processor that receives said image signal, identifies constant points as the top-most, bottom-most, and side points of said image, and uses said constant points to stretch, elongate, or re-size sections of said image signal and produce said distorted image of the individual.

10. The X-ray screening apparatus for security screening an individual of claim 1 including an image viewing screen connected to said at least one processor.

11. The X-ray screening apparatus for security screening an individual of claim 1 including image recording equipment connected to said at least one processor.

12. The X-ray screening apparatus for security screening an individual of claim 1 wherein said image signal embodies an image of the individual and wherein said at least one processor includes a processor that receives said image signal, identifies constant points of said image, and uses said constant points to stretch, elongate, or re-size sections of said image and produce said distorted image of the individual and wherein said at least one processor includes an adjustment processor that provides variable degrees of distortion of said image.

13. A method of security X-ray screening an individual, comprising the steps of:
scanning the individual and producing an image signal representing the individual,
processing said image signal to produce a distorted image of the individual, and
visually displaying said distorted image.

14. The method of security X-ray screening an individual of claim 13 wherein said step of processing said image signal to produce a distorted image of the individual comprises processing said image signal to produce an image of the individual that has acceptable distortion.

15. The method of security X-ray screening an individual of claim 13 wherein said step of processing said image signal to produce a distorted image of the individual comprises processing said image signal to produce an image of the individual that has gross distortion.

16. The method of security X-ray screening an individual of claim 13 wherein said image signal embodies an image of the individual and wherein said step of processing said image signal to produce a distorted image of the individual comprises stretching sections of said image.

17. The method of security X-ray screening an individual of claim 13 wherein said image signal embodies an image of the individual and wherein said step of processing said image signal to produce a distorted image of the individual comprises elongating sections of said image.

18. The method of security X-ray screening an individual of claim 13 wherein said image signal embodies an image of the individual and wherein said step of processing said image signal to produce a distorted image of the individual comprises resizing sections of said image.

19. A security X-ray screening method of claim 13 wherein said image signal embodies an image of the individual and wherein said step of producing a distorted image of the individual comprises identifying constant points of said image, and using said constant points to stretch or elongate or re-size sections of said image to produce a distorted image of the individual.

20. A security X-ray screening method of claim 19 wherein said steps of identifying constant points of said image, and using said constant points to stretch or elongate or re-size sections of said image to produce a distorted image of the individual comprises identifying constant points as the top most, bottom-most, and side points of said image.

21. A security X-ray screening method of claim 19 wherein said steps of identifying constant points of said image, and using said constant points for stretching or elongating or re-sizing sections of said image to produce a distorted image of the individual comprises adjusting said stretching or said elongating or said re-sizing sections of said image to produce an image of the individual that has acceptable distortion.

22. A security X-ray screening method of claim 19 wherein said steps of identifying constant points of said image, and using said constant points for stretching or elongating or re-sizing sections of said image to produce a distorted image of the individual comprises adjusting said stretching or said elongating or said re-sizing sections of said image to produce an image of the individual that has gross distortion.
